(19) United States
(12) Patent Application Publication
(10) Pub. No.: US 2026/0175720 A1
(43) Pub. Date: Jun. 25, 2026

(54) ELECTRIC POWER CONVERSION DEVICE FOR POWER STORAGE DEVICE

(71) Applicant: TOYOTA JIDOSHA KABUSHIKI KAISHA, Toyota-shi (JP)

(72) Inventor: Yutaka ANDO, Anjo-shi (JP)

(73) Assignee: TOYOTA JIDOSHA KABUSHIKI KAISHA, Toyota-shi (JP)

(21) Appl. No.: 19/378,519

(22) Filed: Nov. 4, 2025

(30) Foreign Application Priority Data
Dec. 24, 2024 (JP) 2024-227175

(51) Int. Cl. B60L 53/20; B60L 3/04; H02M 1/00; H02M 1/08; H02M 1/44; H02M 7/521

(52) U.S. Cl. CPC B60L 53/20; B60L 3/04; H02M 1/007; H02M 1/08; H02M 1/44; H02M 7/521; B60L 2210/30

(57) ABSTRACT

An electric power conversion device for a power storage device includes a first control device, an electric power conversion circuit that is configured to output electric power to the power storage device, a drive circuit that generates a drive signal for the electric power conversion circuit by using power supply electric power, a shutoff circuit that shuts off supply of the power supply electric power to the drive circuit, and a detection circuit. The detection circuit is configured to output a shutoff signal to the first control device based on a fact that the shutoff by the shutoff circuit is completed. The shutoff signal indicates that the supply of the power supply electric power to the drive circuit is shut off.

### CROSS-REFERENCE TO RELATED APPLICATION

This application claims priority to Japanese Patent Application No. 2024-227175 filed on Dec. 24, 2024. The disclosure of the above-identified application, including the specification, drawings, and claims, is incorporated by reference herein in its entirety.

### BACKGROUND

### 1. Technical Field

The present disclosure relates to an electric power conversion device for a power storage device.

### 2. Description of Related Art

Japanese Unexamined Patent Application Publication No. 2021-176252 (JP 2021-176252 A) discloses a technique for prohibiting an output from an electric power conversion circuit included in a charger (on-board charger) in a case where an abnormality occurs in the charger during charging of an on-board battery.

### SUMMARY

In JP 2021-176252 A, whether the output from the electric power conversion circuit has been stopped by the prohibition process is checked by using a detection value of a current sensor included in the charger. However, checking that the output from the electric power conversion circuit has been stopped, based on the detection value of the current sensor, is not always easy. For example, even in a case where a current does not flow, the detection value of the current sensor may not be 0 A due to an offset error of the current sensor. In addition, even in a case where the detection value of the current sensor indicates a value close to 0 A, a minute current may flow. Although a current sensor having a small tolerance may be employed, such a current sensor is difficult to acquire and manage, and is expensive.

The present disclosure has been made to solve the above-described issues, and an object thereof is to provide an electric power conversion device for a power storage device that can more accurately detect a stoppage of output from an electric power conversion circuit.

According to one aspect of the present disclosure, an electric power conversion device for a power storage device shown below is provided. The electric power conversion device for a power storage device includes a first control device, an electric power conversion circuit configured to output electric power to the power storage device, a drive circuit configured to generate a drive signal for the electric power conversion circuit by using power supply electric power, a shutoff circuit configured to shut off supply of the power supply electric power to the drive circuit, and a detection circuit. The detection circuit is configured to output, based on completion of a shutoff by the shutoff circuit, a shutoff signal to the first control device. The shutoff signal indicates that the supply of the power supply electric power to the drive circuit has been shut off.

According to the present disclosure, it is possible to provide the electric power conversion device for a power storage device that can more accurately detect the stoppage of output from the electric power conversion circuit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a charging system according to the embodiment of the present disclosure;

FIG. 2 is a diagram showing an example of an electrified vehicle equipped with the charging system shown in FIG. 1;

FIG. 3 is a diagram showing a part of a configuration of a charging circuit shown in FIG. 1;

FIG. 4 is a diagram showing a configuration of a power supply circuit shown in FIGS. 1 and 2; and

FIG. 5 is a flowchart showing a charging control method according to the embodiment of the present disclosure.

### DETAILED DESCRIPTION OF EMBODIMENTS

An embodiment of the present disclosure will be described in detail with reference to the drawings. In the drawings, the same or corresponding parts are denoted by the same reference numerals, and the description thereof will not be repeated. Hereinafter, the electronic control device may be referred to as an “electronic control unit (ECU)”. The ECU includes one or more processors and one or more memories.

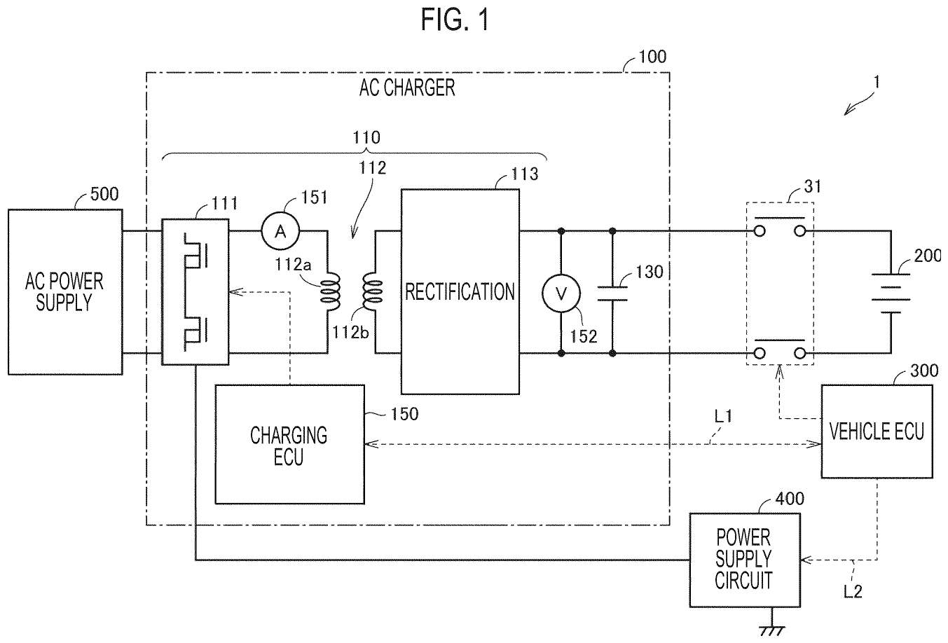

FIG. 1 is a diagram showing a configuration of a charging system according to the embodiment of the present disclosure. With reference to FIG. 1, the charging system 1 includes an AC charger 100, a battery 200, a vehicle ECU 300, a power supply circuit 400, an AC power supply 500, and a charging relay 31. The charging relay 31 is disposed between the AC charger 100 and the battery 200. The charging relay 31 is, for example, an electromagnetic mechanical relay. The charging relay 31 is controlled by the vehicle ECU 300.

The AC power supply 500 is an alternating current power supply that supplies alternating current electric power to the AC charger 100. The AC charger 100 outputs charging electric power for the battery 200. The AC charger 100 includes a charging circuit 110, a capacitor 130, a charging ECU 150, a current sensor 151, and a voltage sensor 152. The charging circuit 110 converts the alternating current electric power supplied from the AC power supply 500 into direct current electric power (charging electric power). The charging circuit 110 includes an electric power conversion circuit 111, an isolation transformer 112, and a rectification circuit 113. The isolation transformer 112 includes a primary coil 112a and a secondary coil 112b. The capacitor 130 is connected in parallel with the battery 200.

The current sensor 151 detects the magnitude of a current flowing through the primary coil 112a. The detection value of the current sensor 151 may be used for the abnormality diagnosis of the electric power conversion circuit 111. The voltage sensor 152 detects the magnitude of a charging voltage output from the AC charger 100 to the battery 200. The charging voltage detected by the voltage sensor 152 corresponds to a voltage of the capacitor 130. Each detection value of the current sensor 151 and the voltage sensor 152 is input to the charging ECU 150 and transmitted from the charging ECU 150 to the vehicle ECU 300.

In this embodiment, the charging system 1 shown in FIG. 1 is mounted on the electrified vehicle, and the AC power supply 500 is attachably and detachably configured to the AC charger 100. The AC power supply 500 in this embodiment is electric vehicle supply equipment (EVSE).

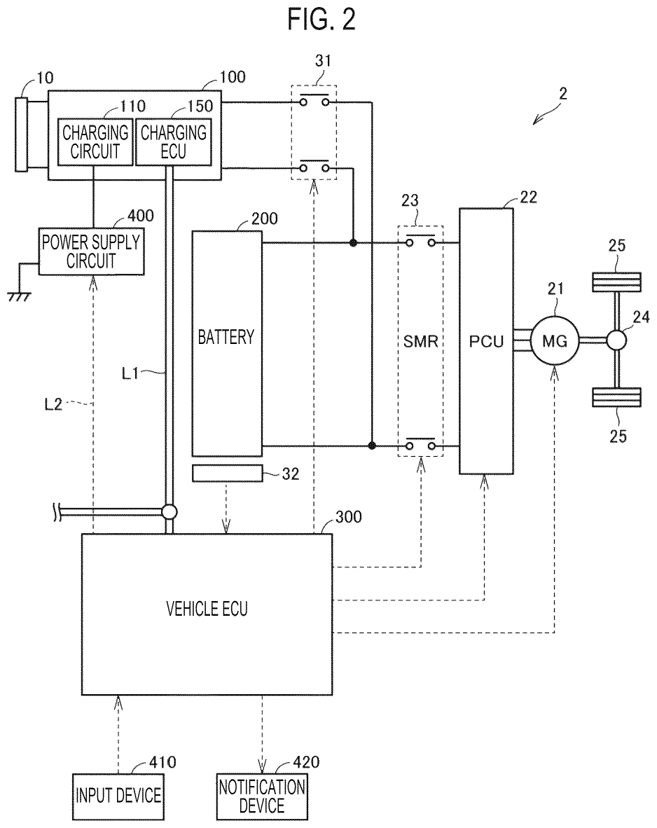

FIG. 2 is a diagram showing an example of an electrified vehicle on which the charging system shown in FIG. 1 is mounted. With reference to FIG. 1 and FIG. 2, the vehicle 2 is an electrified vehicle that includes an inlet 10 electrically connectable to the AC charger 100 and a monitoring unit 32 that monitors a state of the battery 200.

By connecting a connector of a charging cable connected to the AC power supply 500 (EVSE) to the inlet 10, as shown in FIG. 1, the AC power supply 500 and the electric power conversion circuit 111 are electrically connected to each other. As a result, it is possible to supply electric power from the AC power supply 500 to the AC charger 100 (on-board charger) through the charging cable.

The battery 200 is, for example, a secondary battery such as a lithium-ion battery, a nickel-hydrogen battery, or a sodium-ion battery. The type of the secondary battery may be a liquid secondary battery or an all-solid-state secondary battery. A plurality of secondary batteries may form a battery pack. The monitoring unit 32 includes various sensors that detect the state (for example, voltage, current, and temperature) of the battery 200. The detection result of each sensor included in the monitoring unit 32 is output to the vehicle ECU 300. The vehicle ECU 300 and the monitoring unit 32 may function as a battery management system (BMS) that manages a state of charge (SOC) of the battery 200 or the like.

The vehicle 2 further includes a motor generator (MG) 21, a power control unit (PCU) 22, and a system main relay (SMR) 23. The SMR 23 is provided in a circuit connecting the battery 200 and the PCU 22. The SMR 23 is, for example, an electromagnetic mechanical relay. The state (connection/shutoff) of the SMR 23 is controlled by the vehicle ECU 300. The SMR 23 is in a connection state while the vehicle travels.

The MG 21 is driven by the PCU 22 and is configured to rotate drive wheels 25 of the vehicle 2. The PCU 22 may include, for example, a control device including a processor, an inverter, and a converter (none of which are shown). The control device of the PCU 22 is configured to receive an instruction (control signal) from the vehicle ECU 300 and to control the inverter and the converter of the PCU 22 in accordance with the instruction. The output torque of the MG 21 is transmitted to the drive wheels 25 via the power transmission gear 24 that functions as a reducer. In addition, the MG 21 is configured to, for example, perform regenerative power generation while the vehicle decelerates and to supply generated electric power to the battery 200.

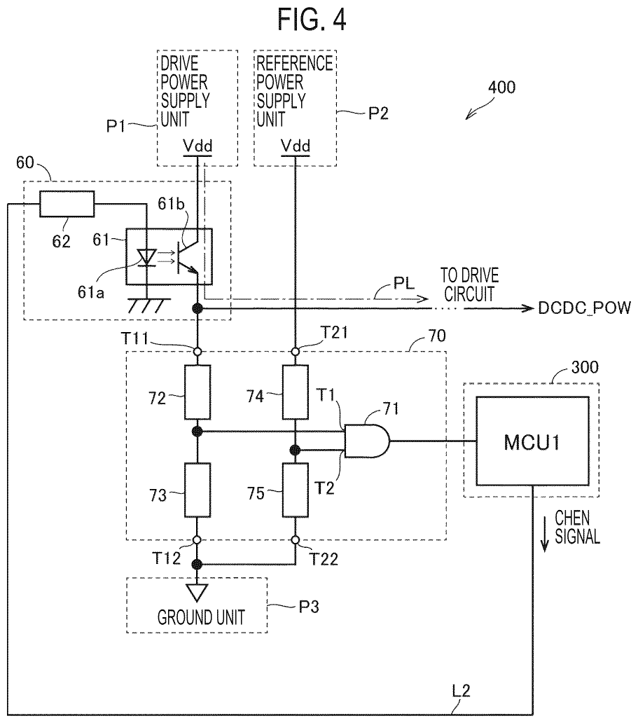

In this embodiment, the vehicle ECU 300 includes a control circuit (hereinafter, referred to as an “MCU 1”). In addition, the charging ECU 150 also includes a control circuit (hereinafter, referred to as an “MCU 2”). Each of the MCUs 1, 2 may be an integrated circuit (IC) based on a microprocessor. The charging ECU 150 and the vehicle ECU 300 are connected to each other via a bus L1. The bus L1 may be a controller area network (CAN) bus. A central gateway (CGW) may be provided between the charging ECU 150 and the vehicle ECU 300. In addition, the vehicle ECU 300 is connected to the power supply circuit 400 via a direct line L2. The direct line L2 is a direct control line that directly connects the devices one-to-one. By using the direct line L2 to transmit the control signal, the control speed is increased. The charging ECU 150 drives the charging circuit 110 using the electric power supplied from the power supply circuit 400. The configuration of the power supply circuit 400 will be described below (see FIG. 4).

In this embodiment, the charging ECU 150 is configured to perform charging control of the battery 200. Specifically, in a case where the vehicle 2 and the AC power supply 500 (FIG. 1) are electrically connected to each other through a charging cable, the charging ECU 150 is activated. In a case where a predetermined charging start condition is satisfied, the vehicle ECU 300 sets the charging relay 31 to a connection state and transmits a charging request signal to the charging ECU 150. In a case where the charging request signal is received, the charging ECU 150 starts external charging (charging using electric power supplied from the outside of the vehicle) of the battery 200 by controlling the charging circuit 110. During the execution of the external charging, the charging relay 31 is maintained in the connection state, and the charging circuit 110 is controlled by the charging ECU 150. The electric power for the external charging is supplied from the AC power supply 500 to the inlet 10 of the vehicle 2 and is input to the charging circuit 110. The electric power is output from the charging circuit 110 to the battery 200. The charging ECU 150 stops the charging of the battery 200 in response to a request from the vehicle ECU 300.

The vehicle ECU 300 has a function (hereinafter, also referred to as a “CHEN function”) of prohibiting the output of the charging circuit 110 in a case where an abnormality occurs in the AC charger 100 during the charging of the battery 200. Specifically, the vehicle ECU 300 transmits the prohibition signal to the power supply circuit 400 in a case where an abnormality occurs in the AC charger 100 during the execution of the external charging. The prohibition signal is transmitted from the vehicle ECU 300 to the power supply circuit 400 through the direct line L2. In a case where the prohibition signal is input to the power supply circuit 400, the power supply circuit 400 does not output the electric power for driving the electric power conversion circuit 111. As a result, the output of the electric power conversion circuit 111 is stopped, and the charging voltage is not applied to the battery 200. With such a CHEN function, the vehicle ECU 300 can directly stop the charging of the battery 200 without the charging ECU 150. Since the vehicle ECU 300 has such a CHEN function, the charging of the battery 200 can be prohibited early and reliably in a case where an abnormality occurs in the AC charger 100, and the excessive charging of the battery 200 can be suppressed.

The vehicle 2 further includes an input device 410 and a notification device 420. The input device 410 outputs a signal corresponding to the input from the user to the vehicle ECU 300. The notification device 420 may include at least one of a display device (for example, a touch panel display), a speaker, and a malfunction indicator lamp (MIL). The notification device 420 may be a meter panel, a head-up display, or a car navigation system.

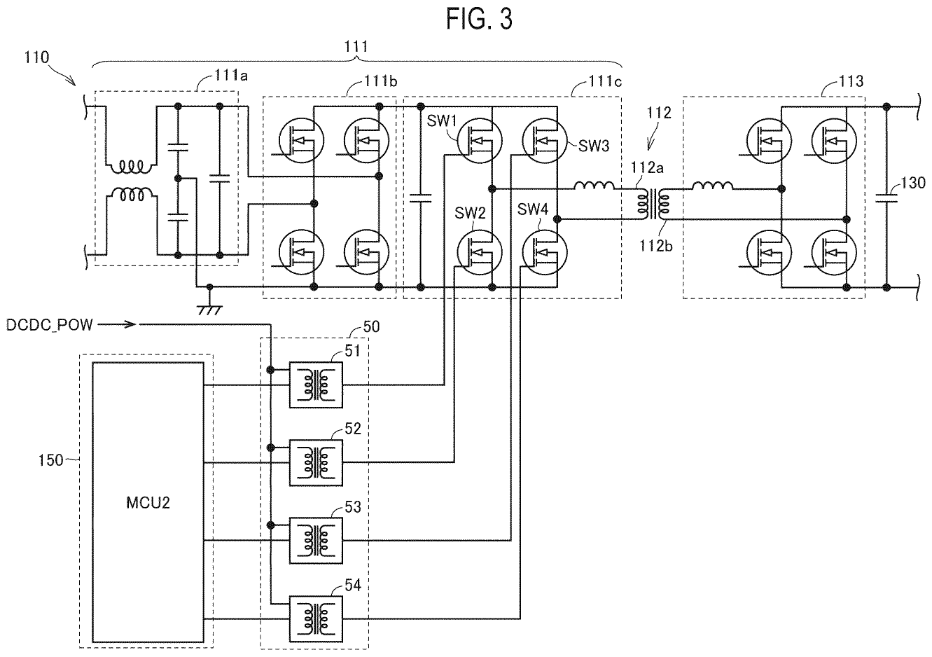

FIG. 3 is a diagram showing a part of the configuration of the charging circuit 110. The charging circuit 110 includes, for example, the electric power conversion circuit 111, an isolation transformer 112, and a rectification circuit 113 which are shown in FIG. 3.

With reference to FIGS. 1 and 3, the electric power conversion circuit 111 includes a filter 111a, an AC/DC conversion circuit 111b, and a DC/AC conversion circuit 111c. The filter 111a removes high-frequency noise included in the alternating current electric power. The AC/DC conversion circuit 111b includes a single-phase bridge circuit and converts the alternating current electric power supplied from the AC power supply 500 (FIG. 1) through the filter 111a into direct current electric power. The DC/AC conversion circuit 111c includes a smoothing capacitor, a single-phase bridge circuit, and an inductor, and converts the direct current electric power output from the AC/DC conversion circuit 111b into alternating current electric power. The alternating current voltage output from the DC/AC conversion circuit 111c is applied to the primary coil 112a. The isolation transformer 112 performs voltage transformation at a ratio corresponding to a winding number ratio between the primary coil 112a and the secondary coil 112b. The transformed alternating current voltage is applied to the secondary coil 112b. The rectification circuit 113 includes an inductor and a single-phase bridge circuit, and converts the alternating current voltage applied to the secondary coil 112b into direct current electric power and outputs the direct current electric power to the capacitor 130. Each bridge circuit is composed of a plurality of switching elements connected to each other.

Each switching element included in the AC/DC conversion circuit 111b, the DC/AC conversion circuit 111c, and the rectification circuit 113 is switched and controlled (ON/OFF controlled) by the MCU 2 of the charging ECU 150. Hereinafter, a configuration for controlling the DC/AC conversion circuit 111c by the MCU 2 will be described.

The single-phase bridge circuit of the DC/AC conversion circuit 111c is composed of switching elements SW1 to SW4. A drive circuit 50 that generates a drive signal for the switching elements SW1 to SW4 is provided in the DC/AC conversion circuit 111c. The drive circuit 50 generates the drive signal by using a power supply electric power (hereinafter, also referred to as “DCDC_POW”) supplied from a drive power supply unit P1 (FIG. 4) described below. In this embodiment, an N-channel type MOSFET is adopted as each of the switching elements SW1 to SW4. “MOS” means metal oxide semiconductor, and “FET” means a field effect transistor. The MOSFET includes a drain, a source, and a gate. Each of the switching elements SW1 to SW4 does not allow a current to flow between the drain and the source in a state where a voltage is not applied to the gate, but allows a drain current to flow from the drain to the source in a case where a positive voltage is applied to the gate with respect to the source. The drive circuit 50 includes transformers 51 to 54. The transformers 51, 52, 53, 54 generate drive signals in response to the control command (for example, a pulse signal) received from the MCU 2, and output the drive signals to the gates of the switching elements SW1, SW2, SW3, SW4, respectively. As a result, the switching element operates in response to the control command output by the MCU 2. Each of the transformers 51 to 54 is a transformer and may function as, for example, a pulse transformer. Each of the switching elements SW1 to SW4 is not limited to the N-channel type MOSFET, and can be appropriately changed.

Details will be described below, but in this embodiment, the supply of the power supply electric power (DCDC_POW) to the drive circuit 50 of the DC/AC conversion circuit 111c is shut off by the CHEN function described above. Meanwhile, each of the AC/DC conversion circuit 111b and the rectification circuit 113 is configured not to stop the operation by the CHEN function. For example, power supply electric power different from the DCDC_POW may be supplied to the drive circuit (for example, a gate drive circuit) for the switching control of each of the AC/DC conversion circuit 111b and the rectification circuit 113. Alternatively, the MCU 2 may directly apply a drive signal (for example, a gate drive signal) to each switching element included in the AC/DC conversion circuit 111b and the rectification circuit 113 without using the drive circuit. However, the present disclosure is not limited to these configurations, and the drive circuit (that is, the drive circuit that stops the operation by the CHEN function) having the same configuration as the drive circuit 50 shown in FIG. 3 may also be provided in the AC/DC conversion circuit 111b and the rectification circuit 113.

The vehicle ECU 300 can check whether the output of the charging circuit 110 is stopped by the CHEN function using the detection value of the current sensor 151 included in the AC charger 100. However, it is not always easy to detect that the output of the charging circuit 110 is stopped based on the detection value of the current sensor 151, with high precision. For example, even in a case where no current flows, the detection value of the current sensor 151 may not be 0 A due to an offset error of the current sensor 151. In addition, even in a case where the detection value of the current sensor 151 shows a value close to 0 A, a minute current may flow. Therefore, the vehicle ECU 300 detects the stop of the output of the charging circuit 110 in cooperation with a power supply circuit 400 described below.

FIG. 4 is a diagram showing a configuration of the power supply circuit 400 shown in FIGS. 1 and 2. The power supply circuit 400 includes a shutoff circuit 60 and a detection circuit 70. The shutoff circuit 60 is configured to shut off the supply of the power supply electric power (DCDC_POW) to the drive circuit 50 shown in FIG. 3 in response to a request from the MCU 1 of the vehicle ECU 300. Specifically, the shutoff circuit 60 includes a switch device 61 and a resistive element 62. The switch device 61 is configured to switch between connecting and shutting off a power supply line PL that supplies the power supply electric power (DCDC_POW) to the drive circuit 50 (FIG. 3). The power supply line PL is a wire that connects the drive power supply unit P1 and the transformers 51 to 54 shown in FIG. 3. The switch device 61 includes a photocoupler. The photocoupler includes a light emitting diode 61a and a phototransistor 61b. The light emitting diode 61a and the phototransistor 61b function as a light emitting element and a light receiving element, respectively. The resistive element 62 is connected to the MCU 1 via a direct line L2 (wire). The light emitting diode 61a is connected to the direct line L2 via the resistive element 62. The phototransistor 61b is provided in the power supply line PL. The photocoupler can perform signal transmission in a state where the photocoupler electrically isolates the power supply line PL from the direct line L2. The switch device 61 is, for example, a normally closed type switch.

In a case where the MCU 1 outputs the prohibition signal (hereinafter, also referred to as a “CHEN signal”) according to the above-described CHEN function to the direct line L2, the CHEN signal flows through the direct line L2 to the resistive element 62 and the light emitting diode 61a. The light emitting diode 61a is energized and emits light in response to the CHEN signal (electric signal). The phototransistor 61b receives the light, and the phototransistor 61b is in a shutoff state (open state). The supply of the power supply electric power (DCDC_POW) from the drive power supply unit P1 to the drive circuit 50 (FIG. 3) is shut off by shutting off the power supply line PL.

The detection circuit 70 is configured to output the shutoff signal to the MCU 1 based on the fact that the shutoff by the shutoff circuit 60 is completed. The shutoff signal is a signal indicating that the supply of the power supply electric power (DCDC_POW) to the drive circuit 50 (FIG. 3) is shut off. Specifically, the detection circuit 70 includes a comparison circuit 71 and resistive elements 72 to 75. The comparison circuit 71 includes an input terminal T1 (first input terminal) and an input terminal T2 (second input terminal). In addition, the detection circuit 70 further includes power supply terminals T11, T21 and ground terminals T12, T22. The power supply terminal T11 is connected to the drive power supply unit P1 via the phototransistor 61b. The resistive elements 72, 73 are provided in a wire that connects the power supply terminal T11 and the ground terminal T12. The wire branches between the resistive elements 72, 73, and the circuit that has branched is connected to the input terminal T1. The power supply terminal T21 is connected to the reference power supply unit P2. The resistive elements 74, 75 are provided in a wire that connects the power supply terminal T21 and the ground terminal T22. The wire branches between the resistive elements 74, 75, and the circuit that has branched is connected to the input terminal T2. Each of the ground terminals T12, T22 is connected to the ground unit P3.

The drive power supply unit P1 outputs power supply electric power (DCDC_POW) for driving the DC/AC conversion circuit 111c to the power supply line PL. The power supply terminal T11 of the detection circuit 70 is connected to the power supply line PL. The reference power supply unit P2 outputs a reference voltage for the detection circuit 70 to the power supply terminal T21. In this embodiment, the power supply voltage output by the drive power supply unit P1 and the reference voltage output by the reference power supply unit P2 are the same voltage (hereinafter, referred to as “Vdd”). Each of the drive power supply unit P1 and the reference power supply unit P2 may receive electric power supply from an auxiliary battery (not shown) of the vehicle 2.

The comparison circuit 71 is configured to output a result of comparing the voltage input to the input terminal T1 and the voltage input to the input terminal T2 to the MCU 1. The comparison circuit 71 is, for example, an AND (logical product) gate. The comparison circuit 71 outputs a value “1” to the MCU 1 when a high-level signal (for example, a voltage signal equal to or higher than a predetermined threshold value) is input to both of the input terminals T1, T2, and outputs a value “0” to the MCU 1 when a low-level signal (for example, a voltage signal lower than the threshold value) is input to at least one of the input terminals T1, T2.

When the phototransistor 61b is in the connection state (closed state), a voltage based on the power supply electric power (DCDC_POW) is input to the input terminal T1. Specifically, a value (first divided value of Vdd) obtained by dividing Vdd by the resistive elements 72, 73 is input to the input terminal T1. The first divided value of Vdd corresponds to the high-level signal. On the other hand, when the phototransistor 61b is in the shutoff state, a voltage based on the power supply electric power (DCDC_POW) is not input to the input terminal T1. In this case, a voltage value (ground voltage) corresponding to the ground unit P3 is input to the input terminal T1. The ground voltage corresponds to the low-level signal.

A predetermined reference voltage is input to the input terminal T2 regardless of the state (connection/shutoff) of the phototransistor 61b. Specifically, a value (second divided value of Vdd) obtained by dividing Vdd by the resistive elements 74, 75 is input to the input terminal T2. In this embodiment, the reference voltage (second divided value of Vdd) input to the input terminal T2 is set to match the first divided value of Vdd (voltage based on DCDC_POW). That is, the second divided value of Vdd corresponds to the high-level signal.

A signal indicating a value “0” in the output signal of the comparison circuit 71 corresponds to the shutoff signal. While the phototransistor 61b is in the connection state, the comparison circuit 71 outputs a signal indicating a value “1”, and the shutoff signal is not output from the detection circuit 70 to the MCU 1. The shutoff signal is generated in association with the shutoff operation of the phototransistor 61b, and the shutoff signal is output from the detection circuit 70 to the MCU 1. The fact that the MCU 1 does not receive the shutoff signal means that the power supply electric power is supplied from the drive power supply unit P1 to the drive circuit 50 (FIG. 3). The fact that the MCU 1 receives the shutoff signal means that the supply of the charging electric power from the AC charger 100 to the battery 200 is stopped by the stoppage of output from the electric power conversion circuit 111.

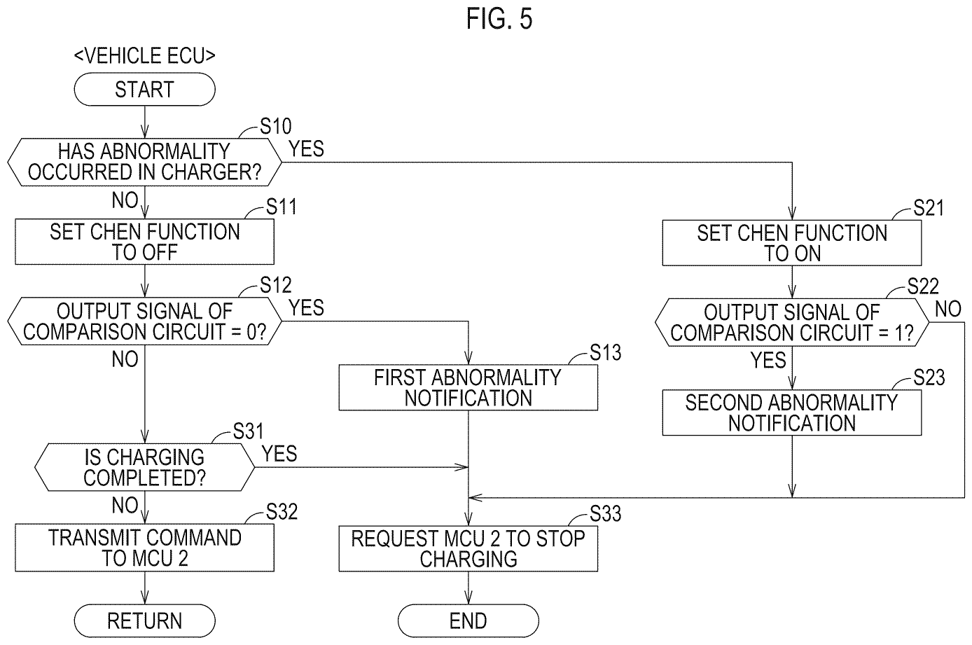

FIG. 5 is a flowchart showing control executed by the vehicle ECU 300 during the external charging. “S” in the flowchart means a step.

With reference to FIGS. 1 to 4 and FIG. 5, in S10, the vehicle ECU 300 determines whether an abnormality has occurred in the AC charger 100. The vehicle ECU 300 may determine whether an abnormality has occurred in the AC charger 100 using at least one of the detection value of each sensor (for example, the current sensor 151 and the voltage sensor 152) included in the AC charger 100 and the detection value of each sensor (for example, the current sensor, the voltage sensor, and the temperature sensor) included in the monitoring unit 32. For example, in a case where any sensor included in the AC charger 100 outputs an abnormal detection value that is not observed in normal operation, the vehicle ECU 300 may determine that an abnormality has occurred in the AC charger 100.

In a case where it is determined that the AC charger 100 is normal (NO in S10), the vehicle ECU 300 sets the CHEN function to OFF in S11. In a case where the CHEN function is set to OFF, the MCU 1 does not transmit the CHEN signal to the shutoff circuit 60. Therefore, the light emitting diode 61a does not emit light, and the phototransistor 61b is in the connection state. Next, the vehicle ECU 300 determines whether the output signal of the comparison circuit 71 indicates a value “0” in S12.

In a case where the output signal of the comparison circuit 71 indicates a value “1” (NO in S12), the vehicle ECU 300 determines whether the charging is completed based on the state of the battery 200 in S31. For example, the vehicle ECU 300 may determine that the charging is completed in a case where the SOC of the battery 200 reaches the target value. In addition, the vehicle ECU 300 may determine that the charging is completed in a case where a predetermined time or longer has elapsed from the start of charging. In a case where the charging is not completed (NO in S31), the vehicle ECU 300 transmits a command to the MCU 2 in S32. The vehicle ECU 300 may determine the command to the MCU 2 based on, for example, the state of the battery 200. The vehicle ECU 300 may request the maximum electric power that can be accepted by the battery 200 to the MCU 2. In addition, the vehicle ECU 300 may request the MCU 2 to suppress the charging electric power in a case where, for example, the temperature or the SOC of the battery 200 is equal to or higher than a predetermined value. In a case where the process of S32 is executed, the process returns to the first step (S10). In a case where the charging is completed (YES in S31), the vehicle ECU 300 requests the MCU 2 to stop the charging (specifically, to stop the operation of the AC charger 100) in S33. As a result, the charging of the battery 200 is ended. The process flow shown in FIG. 5 ends.

In a case where the output signal of the comparison circuit 71 indicates a value “0” (YES in S12), the vehicle ECU 300 controls the notification device 420 such that the user is notified that an abnormality has occurred in the power supply circuit 400 in S13 (first abnormality notification). Specifically, the vehicle ECU 300 causes the notification device 420 to notify of a failure of the drive power supply of the AC charger 100 (electric power conversion circuit 111). The first MIL (first lamp) may be turned on by this notification process. The output signal of the comparison circuit 71 indicating a value “0” means that the shutoff signal is input to the MCU 1. In a case where the process of S13 is executed, the process proceeds to S33. The process of S33 is executed, and the charging of the battery 200 is ended. The process flow shown in FIG. 5 also ends.

In a case where it is determined that an abnormality has occurred in the AC charger 100 (YES in S10), the vehicle ECU 300 sets the CHEN function to ON in S21. In a case where the CHEN function is set to ON, the MCU 1 transmits the CHEN signal to the shutoff circuit 60. Therefore, the light emitting diode 61a emits light, and the phototransistor 61b is in the shutoff state. Since the shutoff signal is input to the MCU 1 in conjunction with the shutoff operation of the phototransistor 61b, the vehicle ECU 300 easily and reliably detects the stop of the output of the electric power conversion circuit 111.

Subsequently, the vehicle ECU 300 determines whether the output signal of the comparison circuit 71 indicates a value “1” in S22. In a case where the output signal of the comparison circuit 71 indicates the value “1” (YES in S22), the vehicle ECU 300 controls the notification device 420 such that the abnormality in the power supply circuit 400 is notified to the user in S23 (second abnormality notification). Specifically, the vehicle ECU 300 causes the notification device 420 to notify that the CHEN function is not operating normally. The second MIL (second lamp) may be turned on by the notification process. In a case where the process of S23 is executed, the process proceeds to S33. In addition, in a case where the output signal of the comparison circuit 71 indicates a value “0” (NO in S22), the process skips S23 and proceeds to S33. The process of S33 is executed, and the charging of the battery 200 is ended. The process flow shown in FIG. 5 also ends.

As described above, the electric power conversion device for the power storage device according to this embodiment includes the first control device (vehicle ECU 300), an electric power conversion circuit (charging circuit 110) configured to output electric power to the power storage device (battery 200), a drive circuit 50 that generates a drive signal for the electric power conversion circuit by using the power supply electric power, a shutoff circuit 60 that shuts off the supply of the power supply electric power to the drive circuit 50, and a detection circuit 70. The detection circuit 70 is configured to output the shutoff signal to the first control device based on the fact that the shutoff by the shutoff circuit 60 is completed. The shutoff signal indicates that the supply of the power supply electric power to the drive circuit 50 is shut off. With such a configuration, the first control device can more accurately detect the stoppage of output from the electric power conversion circuit.

In addition, the drive circuit 50 generates a drive signal such that the switching elements SW1 to SW4 operate in response to the control command in a case where the control command is received from the second control device (charging ECU 150). The shutoff circuit 60 is configured to shut off the supply of the power supply electric power to the drive circuit 50 in response to a request (CHEN signal) from the first control device (vehicle ECU 300). With such a configuration, the first control device can directly execute the power supply shutoff of the drive circuit 50 without the second control device and stop the electric power output from the electric power conversion circuit to the power storage device.

In the above-described embodiment, the driving of all of the switching elements SW1 to SW4 included in the DC/AC conversion circuit 111c is prohibited in response to the prohibition signal output by the vehicle ECU 300. However, the present disclosure is not limited to this, and the driving of some (for example, two or three) of the switching elements SW1 to SW4 may be prohibited. For example, the driving of the minimum number of switching elements needed to stop the output of the DC/AC conversion circuit 111c may be prohibited.

The switch device 61 may be, for example, a normally open type switch. The signal for stopping the energization of the light emitting diode 61a may be the prohibition signal. The voltage of the drive power supply unit P1 and the voltage of the reference power supply unit P2 need not match. The comparison circuit 71 may be a comparison circuit (comparator) other than the AND gate. In a case where the voltage input to the input terminal T1 is higher than the reference voltage in a state where the reference voltage is input to the input terminal T2 from the reference power supply unit P2, the comparison circuit 71 may output a high-level signal (a signal that is not the shutoff signal) to the MCU 1, and in a case where the voltage input to the input terminal T1 is lower than the reference voltage, the comparison circuit 71 may output a low-level signal (the shutoff signal) to the MCU 1. In addition, even in a form in which the comparison circuit 71 changes the output voltage in accordance with a difference between the voltage input to the input terminal T1 and the voltage input to the input terminal T2, the MCU 1 can determine whether the power supply line PL is shut off.

The above-described circuit configuration related to the electric power conversion device for the power storage device may be applied to devices other than the AC charger. The above-described circuit configuration may be applied to a wireless electric power transmission (WPT) device. In addition, the electric power conversion device for the power storage device may be used in a vehicle (ship, airplane, train, and the like) other than the automobile, an unmanned mobile object (unmanned transport vehicle, automatic cleaner, agricultural machine, construction machine, robot, drone, space probe, and the like), or a building (residence, factory, and the like).

The embodiments disclosed this time should be considered illustrative and not restrictive in all respects. The scope of the present disclosure is defined not by the detailed description of embodiments but by the claims, and is intended to cover all equivalents and all modifications within the scope of the claims.

What is claimed is:

1. An electric power conversion device for a power storage device, the electric power conversion device comprising:
a first control device;
an electric power conversion circuit configured to output electric power to the power storage device;
a drive circuit configured to generate a drive signal for the electric power conversion circuit by using power supply electric power;
a shutoff circuit configured to shut off supply of the power supply electric power to the drive circuit; and
a detection circuit configured to output, based on completion of a shutoff by the shutoff circuit, a shutoff signal to the first control device,
wherein the shutoff signal indicates that the supply of the power supply electric power to the drive circuit has been shut off.

2. The electric power conversion device according to claim 1, further comprising a second control device configured to control the electric power conversion circuit, wherein:
the electric power conversion circuit includes a plurality of switching elements;
the drive circuit is configured to generate the drive signal such that the switching elements operate according to a control command when receiving the control command from the second control device; and
the shutoff circuit is configured to shut off the supply of the power supply electric power to the drive circuit in response to a request from the first control device.

3. The electric power conversion device according to claim 1, wherein:
the shutoff circuit includes a switch device configured to switch between connection and shutoff of a power supply line that supplies the power supply electric power to the drive circuit;
the detection circuit includes a comparison circuit that includes a first input terminal and a second input terminal;
a voltage based on the power supply electric power is input to the first input terminal when the switch device is in a connection state;
the voltage based on the power supply electric power is not input to the first input terminal when the switch device is in a shutoff state;
a reference voltage that is predetermined is input to the second input terminal; and
the comparison circuit is configured to output, to the first control device, a result of comparing a voltage input to the first input terminal with the voltage input to the second input terminal.

4. The electric power conversion device according to claim 3, wherein:
the reference voltage that is predetermined is set to match the voltage based on the power supply electric power; and
the comparison circuit is an AND gate.

5. The electric power conversion device according to claim 3, wherein:
the switch device includes a photocoupler; and
the photocoupler includes
a light emitting diode configured to emit light in response to an electric signal from the first control device, and
a phototransistor configured to switch between the connection and the shutoff of the power supply line in response to the light emitted by the light emitting diode.
